(19) United States
(12) Patent Application Publication
(10) Pub. No.: US 2026/0271044 A1
(43) Pub. Date: Sep. 10, 2026

(54) MEASURING NEIGHBOR NETWORK ENTITY INTERFERENCE AT A USER EQUIPMENT FOR INTERFERENCE MITIGATION

(71) Applicant: QUALCOMM Incorporated, San Diego, CA (US)

(72) Inventors: Qian ZHANG, Basking Ridge, NJ (US); Tao LUO, San Diego, CA (US); Yan ZHOU, San Diego, CA (US)

(21) Appl. No.: 19/070,985

(22) Filed: Mar. 5, 2025

(51) Int. Cl. H04W 72/541; H04L 5/00; H04W 24/10

(52) U.S. Cl. CPC H04W 72/541; H04L 5/0048; H04W 24/10

(57) ABSTRACT

Certain aspects of the present disclosure provide techniques for wireless communications by a device. A method generally includes receiving, from a first network entity, a first indication of a measurement resource associated with measurement of interference from a second network entity to the CPE, the measurement resource associated with a second indication from the second network entity to the first network entity of the measurement resource, performing, on the measurement resource, the measurement of interference from the second network entity to the CPE, and transmitting, to the first network entity, a report regarding the measurement resource.

### INTRODUCTION

### Field of the Disclosure

Aspects of the present disclosure relate to wireless communications, and more particularly, to techniques for measuring neighbor network entity interference at a user equipment for interference mitigation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a customer premises equipment (CPE). The method includes receiving, from a first network entity, a first indication of a measurement resource associated with measurement of interference from a second network entity to the CPE, the measurement resource associated with a second indication from the second network entity to the first network entity of the measurement resource; performing, on the measurement resource, the measurement of interference from the second network entity to the CPE; and transmitting, to the first network entity, a report regarding the measurement resource.

Certain aspects provide a method for wireless communications by a first network entity. The method includes receiving, from a second network entity, a first indication of a measurement resource; providing, to a CPE, a second indication of the measurement resource; receiving, from the CPE, a report regarding the measurement resource; and performing an action based on the report.

Certain aspects provide a method for wireless communications by a second network entity. The method includes sending, to a first network entity, an indication of a measurement resource associated with measurement of interference from the second network entity to the first network entity; receiving, from the first network entity, information associated with a measurement of interference, at a CPE, on the measurement resource; and performing an action based on the received information.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a diagram illustrating examples of full-duplex communication in a wireless network.

FIG. 6 is a diagram illustrating examples of interference associated with full duplex communications in a wireless network.

FIG. 7 is a diagram illustrating an example of interference associated with a customer premises equipment (CPE).

FIG. 8 is a diagram illustrating an example process of measuring and reporting interference at a CPE from a neighbor network entity to support interference mitigation at the CPE.

FIG. 9 depicts a process flow for indicating a measurement resource to a CPE to enable accurate measurement and reporting of interference to support interference mitigation at the CPE.

FIG. 10 depicts a process flow for configuring a CPE with rules to handle collisions between a configured transmission or reference signal and an indicated measurement resource usable to measure interference.

FIG. 11 depicts a process flow for enabling a first network entity to perform actions to mitigate interference at a CPE based on reported interference measurements regarding an indicated measurement resource.

FIG. 12 depicts a process flow for enabling a second network entity to perform actions to mitigate interference at a CPE based on reported interference measurements regarding an indicated measurement resource.

FIG. 13 depicts a method for wireless communications.

FIG. 14 depicts another method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for measuring neighbor network entity interference at a user equipment for interference mitigation.

As wireless communication systems grow, an increasing number of wireless communication devices, such as user equipments (UEs) and network entities (NEs) are deployed. Furthermore, such wireless communication devices may be deployed in close proximity to another and/or by different operators. This growth increases potential for interference between devices. For example, interference between wireless communication devices may include cross-link interference in which one or more signals from a first wireless communication device interfere with receptions of a second wireless communication device, thereby degrading device performance and resource efficiency.

Some UEs and NEs support full duplex (FD) or sub-band full duplex (SBFD) modes. FD allows for simultaneous transmission and reception on the same frequency. SBFD allows for simultaneous transmission and reception of transmissions on separate sub-bands. While FD and SBFD modes increase spectral efficiency, they also introduce additional interference risks. In some examples, network entities, such as a next generation NodeB (gNB) operating using FD or SBFD, can experience inter-gNB cross-link interference. For example, a signal transmitted by a first gNB may be received at a second gNB, thereby creating inter-gNB cross-link interference between the first gNB and the second gNB. Network entities may measure inter-gNB cross-link interference by exchanging one or more measurement resources. For example, the first gNB may signal an indication of a measurement resource, and the second gNB may measure interference on the measurement resource. The measurement resource may be a reference signal resource or a zero-power reference signal resource.

In some cases, UEs may include a customer premises equipment (CPE) and/or a wireless access backhaul (WAB) (CPE/WAB). A CPE includes a user device that connects to a wireless network for fixed internet access on the user device. For example, a CPE may provide local connectivity (e.g., via WiFi or Ethernet), and may use a radio access network (RAN) connection, such as a Uu interface connection, to provide Internet connectivity. CPEs may operate with a larger antenna array as compared to an enhanced mobile broadband (eMBB) UE, such as a smart phone. The larger antenna arrays of a CPE increase range and coverage area. However, the larger antenna array increases cross-link interference, from one or more network entities, at the CPEs downlink reception, thereby reducing data throughput, increasing latency, and increasing error rates.

It may be beneficial for a CPE to provide a first network entity (e.g. a serving network entity of the CPE) with a report regarding interference at the CPE from a second network entity (e.g. a neighboring network entity, an aggressor network entity). However, it may be unclear how a CPE should measure interference from the second network entity. Without common understanding of how interference between a CPE and a second neighbor entity is to be measured and reported, it may be difficult or impossible for the first or second network entity to receive accurate reports regarding interference. This hinders the ability of the first and second network entity to perform actions to mitigate interference at the CPE, thereby reducing data throughput and increasing latency at the CPE due to unmitigated interference.

Aspects of the present disclosure relate generally to measuring neighbor network entity interference at a user equipment. Some aspects more specifically provide signaling for a first network entity to indicate a measurement resource to the CPE. Notably, in some aspects, the measurement resource may be a measurement resource configured at the first network entity, by a second network entity, for interference measurement at the first network entity regarding interference from the second network entity. The CPE may measure interference at the CPE from a second network entity on the measurement resource. The CPE may then transmit a report regarding the measurement resource to the first network entity. In some aspects, one of the first network entity or the second network entity may perform an action to mitigate interference at the CPE based on the report. For example, a first network entity may send, to the CPE, one or more transmissions with an increased transmission power for one or more downlink resources corresponding to interference at the second network entity, such as based on the report and any information exchanged between the first network entity and the second network entity related to interference on the one or more downlink resources. A given network entity may thus perform actions based on the report and/or exchanged information from another network entity to mitigate interference at the CPE, thereby reducing latency and increasing throughput.

In other aspects, techniques are provided that enable a CPE to handle collisions, such as when an indicated measurement resource is scheduled to overlap with a different scheduled transmission or reference signal. For example, a CPE may drop or perform a configured downlink channel transmission that conflicts with a scheduled measurement resource based on priority levels associated with the configured downlink channel transmission and the measurement resource. Techniques for handling collisions enable the CPE to select a transmission to drop in the presence of scheduling conflicts, improving resource scheduling efficiency and interference mitigation.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

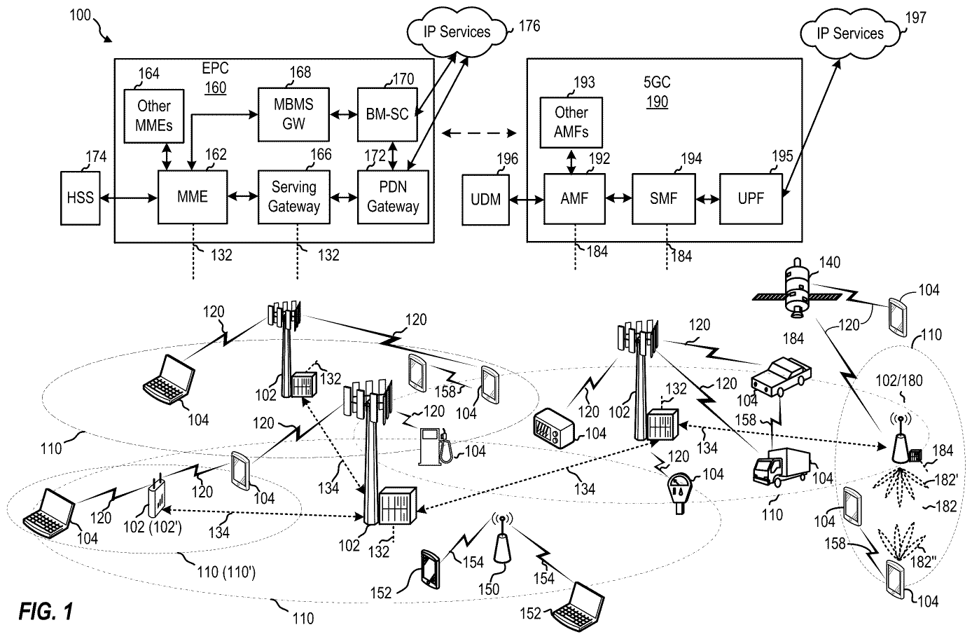

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. In some aspects, UE 104 may include customer premises equipment (CPE) and/or a wireless access backhaul (WAB) (CPE/WAB) that connects to a wireless network for fixed internet access on UE 104. The CPE may provide local connectivity (e.g., via WiFi or Ethernet), and may use a radio access network (RAN) connection, such as a Uu interface connection, to provide Internet connectivity. In some aspects, the RAN connection may be provided by a 5G modem. CPEs may operate with a larger antenna array as compared to an enhanced mobile broadband (eMBB) UE, such as a smart phone, thereby enabling the CPE to operate at a highest transmit power.

In some cases, UE 104 may include or implement a Wireless Access Backhaul (WAB). The WAB enables base-station functions to communicate with UEs for access service, and UE functions to communicate with a second base station for backhauling purposes. As used herein, “backhauling” refers to a process of transferring data from a smaller, distributed network, such as a gNB to a central core network.

A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

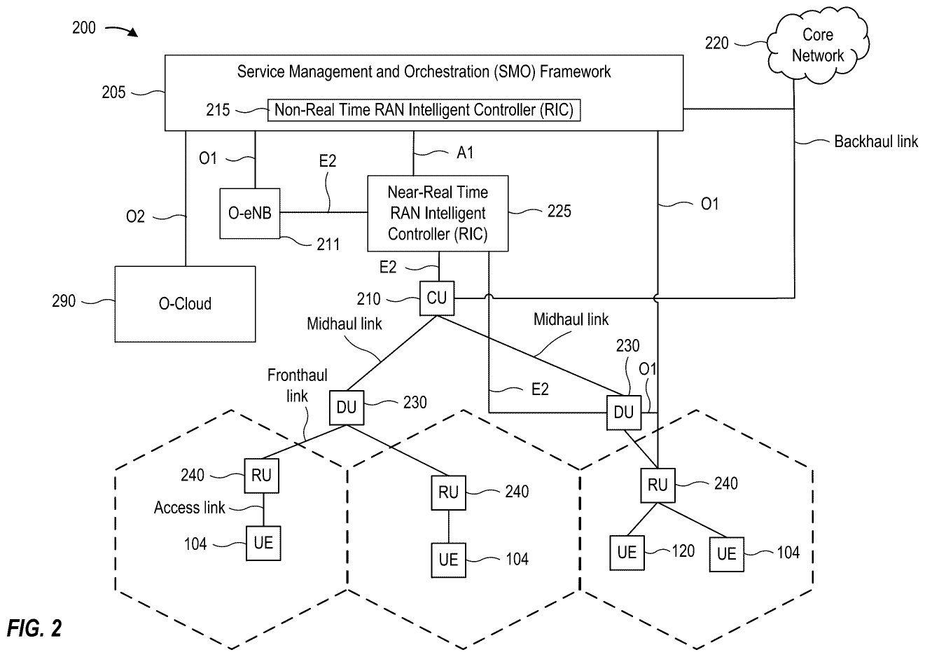

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a sub-band. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

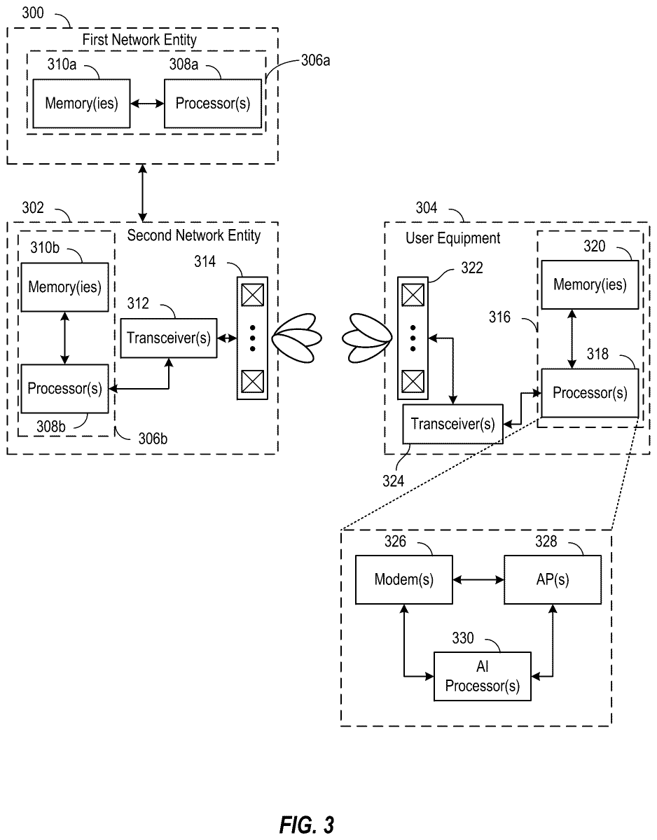

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

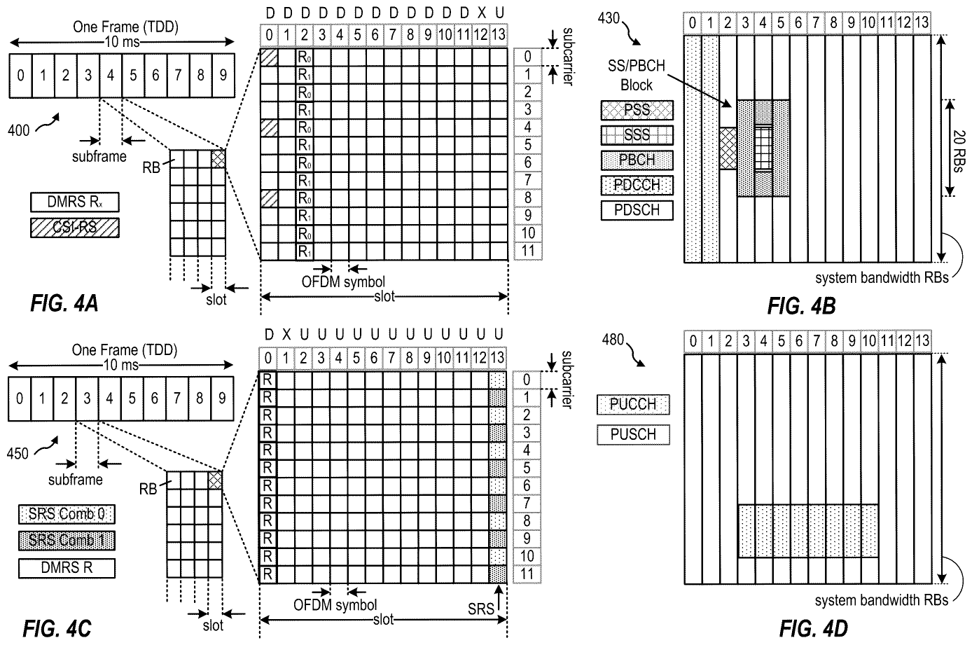

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Measuring Neighbor Network Entity Interference at a User Equipment for Interference Mitigation

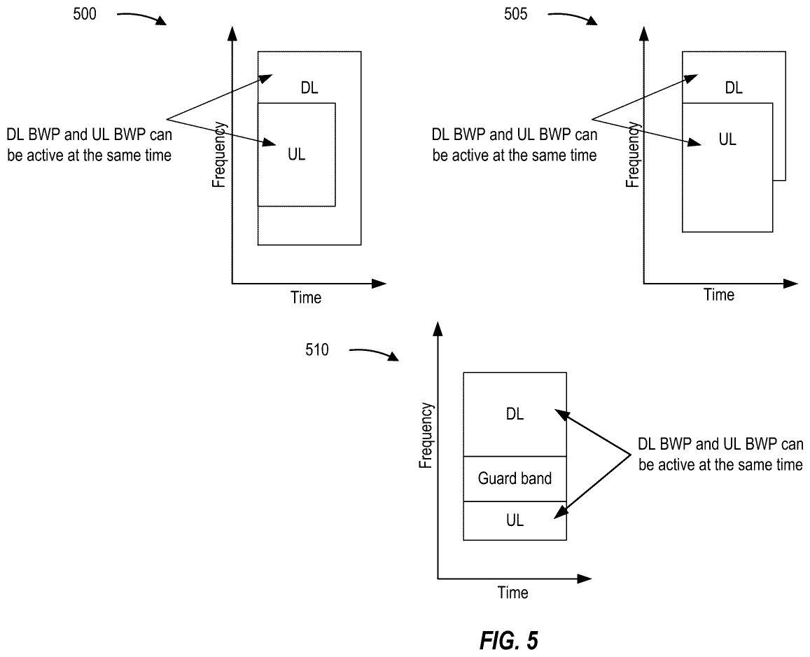

FIG. 5 is a diagram illustrating examples 500, 505, and 510 of full-duplex communication in a wireless network, in accordance with the present disclosure. “FD communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “HD communication” in a wireless network refers to unidirectional communications (e.g., only downlink communication or only uplink communication) between devices at a given time (e.g., in a given slot or a given symbol).

As shown in FIG. 5, examples 500 and 505 show examples of in-band full-duplex (IBFD) communication. In IBFD, a UE may transmit an uplink communication to a base station and receive a downlink communication from the base station on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of SBFD communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a TDD band. In this case, the frequency resources used for downlink communication may be separated from the frequency resources used for uplink communication, in the frequency domain, by a guard band.

SBFD may increase an uplink duty cycle, improve uplink coverage, and reduce latency, because it is possible to transmit an uplink signal in an uplink sub-band in downlink only or in flexible slots. SBFD may enhance system capacity, resource utilization, and spectrum efficiency. SBFD may enable flexible and dynamic uplink and downlink resource adaption according to uplink and downlink traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and msg3. A RACH configuration may indicate a quantity of synchronization signal blocks (SSBs) per RO and power information for PRACH messages (e.g., preambles).

As indicated above, FIG. 5 is provided as an example. Other examples may differ from what is described with respect to FIG. 5.

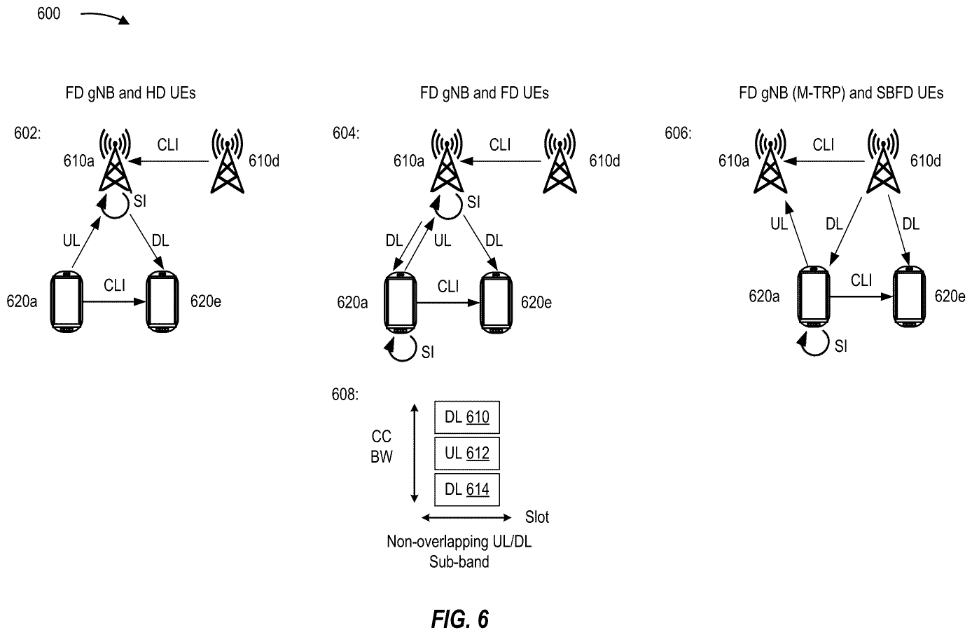

FIG. 6 is a diagram 600 illustrating examples of interference associated with full duplex communications in a wireless network. Diagram 600 includes network nodes 610a, 610d, and UEs 620a, 620e.

In some aspects, network nodes 610a, 610d may be examples of the BS 102 depicted and described with respect to FIG. 1, the first network entity 300 or the second network entity 302 depicted and described with respect to FIG. 3, or disaggregated base stations depicted and described with respect to FIG. 2. Similarly, UEs 620a, 620e may be examples of UE 104 depicted and described with respect to FIG. 1 or the UE 304 depicted and described with respect to FIG. 3. However, in other aspects, UEs 620a, 620e may be another type of wireless communications device and network nodes 610a, 610d may be another type of network entity or network node, such as those described herein.

As shown by reference number 602, a full duplex network node (e.g., network node 610a) may communicate with half duplex UEs. The full duplex network node may be subjected to cross-link interference from another full duplex network node (e.g., network node 610d). The cross-link interference from the other full duplex network node may be inter-network-node cross-link interference. The full duplex network node may experience self-interference. The full duplex network node may receive an uplink transmission from a first half duplex UE (e.g., UE 620a), and the full duplex network node may transmit a downlink transmission to a second half duplex UE (e.g., UE 620e). The full duplex network node may receive the uplink transmission and transmit the downlink transmission on the same slot (e.g., a simultaneous reception/transmission). The second half duplex UE may be subjected to cross-link interference from the first half duplex UE (e.g., inter-UE cross-link interference).

As shown by reference number 604, a full duplex network node (e.g., network node 610a) may communicate with full duplex UEs. The full duplex network node may be subjected to cross-link interference from another full duplex network node (e.g., network node 610d). The full duplex network node may experience self-interference. The full duplex network node may transmit a downlink transmission to a first full duplex UE (e.g., UE 620a), and the full duplex network node may receive an uplink transmission from the first full duplex UE at the same time as the downlink transmission. The full duplex network node may transmit a downlink transmission to a second full duplex UE (e.g., UE 620e). The second half duplex UE may be subjected to cross-link interference from the first half duplex UE. The first UE may experience self-interference.

As shown by reference number 606, a first full duplex network node (e.g., network node 610a), which may be associated with or include multiple TRPs, may communicate with SBFD UEs. The first full duplex network node may be subjected to cross-link interference from a second full duplex network node (e.g., network node 610d). The first full duplex network node may receive an uplink transmission from a first SBFD UE (e.g., UE 620a). The second full duplex network node may transmit downlink transmissions to both the first SBFD UE and a second SBFD UE (e.g., UE 620e). The second SBFD UE may be subjected to cross-link interference from the first SBFD UE. The first SBFD UE may experience self-interference.

As shown by reference number 608, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 612 may be between, in a frequency domain, a first downlink resource 610 and a second downlink resource 614. The first downlink resource 610, the second downlink resource 614, and the uplink resource 612 may all be associated with the same time.

An SBFD operation may be associated with a TDD or an intra-band carrier aggregation (CA). The SBFD operation may increase an uplink duty cycle, which may result in a latency reduction (e.g., an uplink signal may be transmitted in downlink-only slots, or a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

As indicated above, FIG. 6 is provided as an example. Other examples may differ from what is described with regard to FIG. 6. For a network node that serves multiple UEs, one or more UEs, of the multiple UEs, may be CPEs or WABs. Each CPE/WAB may also serve multiple UEs. For example, a CPE may further connect to multiple UEs via wired links. A WAB may further connect to multiple UEs via wireless links. A UE, such as a CPE/WAB, may have a larger array and/or a higher transmit power, as compared to another UE, such as a smart phone. The larger array and/or the higher transmit power may render the CPE/WAB vulnerable to interference. Aspects described herein provide signaling for a first network entity to indicate a measurement resource to a CPE that is usable to measure interference at the CPE from a second network entity on the measurement resource. The CPE may then transmit a report regarding the measurement resource to the first network entity. The first network entity or the second network entity may then perform an action to mitigate interference at the CPE based on the report, thereby providing the technical benefit of increasing performance and throughput at the CPE and the network entities.

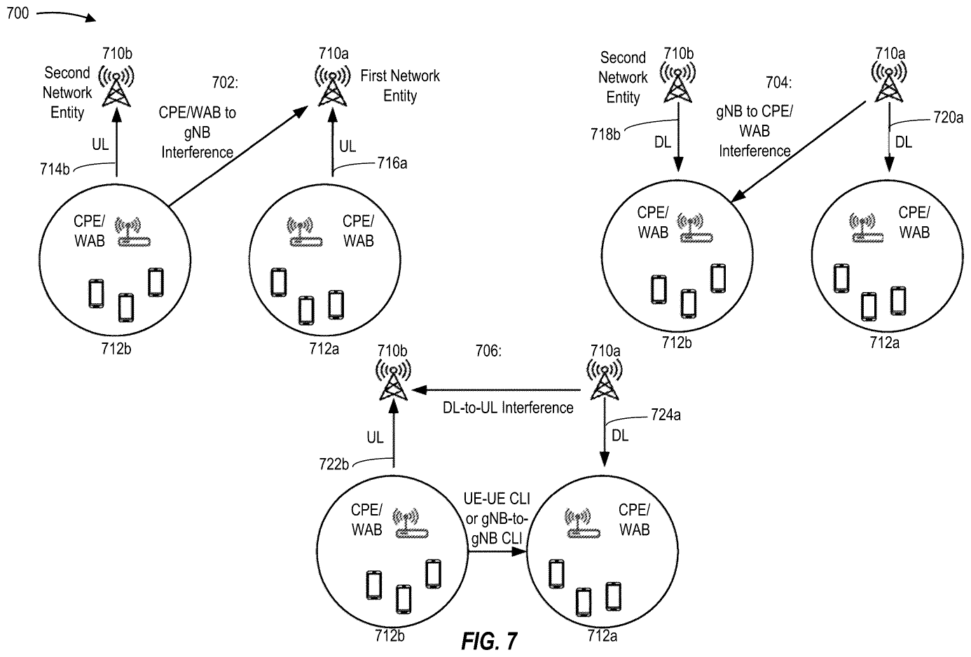

FIG. 7 is a diagram 700 illustrating examples of interference associated with a CPE. Diagram 700 depicts communications in a network between a first network entity 710a, a second network entity 710b, a first set of UEs 712a, and a second set of UEs 712b. In some aspects, first network entity 710a and second network entity 710b may be examples of the BS 102 depicted and described with respect to FIG. 1, the first network entity 300 or the second network entity 302 depicted and described with respect to FIG. 3, or disaggregated base stations depicted and described with respect to FIG. 2. Similarly, first set of UEs 712a, and second set of UEs 712b may include examples of UE 104 depicted and described with respect to FIG. 1 or the UE 304 depicted and described with respect to FIG. 3. However, in other aspects, first set of UEs 712a, and second set of UEs 712b may be another type of wireless communications device and first network entity 710a and second network entity 710b may be another type of network entity or network node, such as those described herein.

In some aspects, first network entity 710a (e.g., first gNB) may provide coverage for a first set of UEs 712a (e.g., CPEs/WABs and/or non-CPEs/WABs). The first network entity 710a may communicate with the first set of UEs 712a. A second network entity 710b (e.g., neighbor second gNB) may be associated with a second set of UEs 712b (e.g., CPEs/WABs and/or non-CPEs/WABs). The second network entity 710b may perform downlink/uplink transmissions to the second set of UEs 712b.

As shown by reference number 702, in a first scenario, an uplink transmission 714b by a UE 712b (e.g., CPE/WAB) served by the second network entity 710b may interfere with an uplink reception 716a of the first network entity 710a, thereby causing a CPE/WAB-to-gNB interference. As shown by reference number 704, in a second scenario, a downlink transmission 720a served by the first network entity 710a may interfere with a downlink reception 718b of UE 712b (e.g., CPE/WAB) of the second network entity 710b, thereby causing a gNB-to-CPE/WAB interference. As shown by reference number 706, in a third scenario, an uplink transmission 722b of a UE 712b (e.g., CPE/WAB) served by the second network entity 710b may interfere with a downlink reception 724a of UE 712a (e.g., CPE/WAB) served by the first network entity 710a, thereby causing a UE-to-UE CLI for a dynamic TDD and SBFD scenario. In one example, when a WAB is associated with a DU functionality, a gNB-to-gNB CLI may result. In other examples, gNB-to-gNB CLI may occur when first network entity 710a is transmitting downlink data on a same frequency band being used by second network entity 710b while receiving uplink data. gNB-to-gNB CLI may similarly occur when first network entity 710a is receiving uplink data on a same frequency band being used by second network entity 710b to transmit downlink data. In some cases, one of first or second network entities 710a, 710b may indicate, to the other network entity, a measurement resource usable to measure CLI between the network entities.

As indicated above, FIG. 7 is provided as an example. Other examples may differ from what is described with regard to FIG. 7.

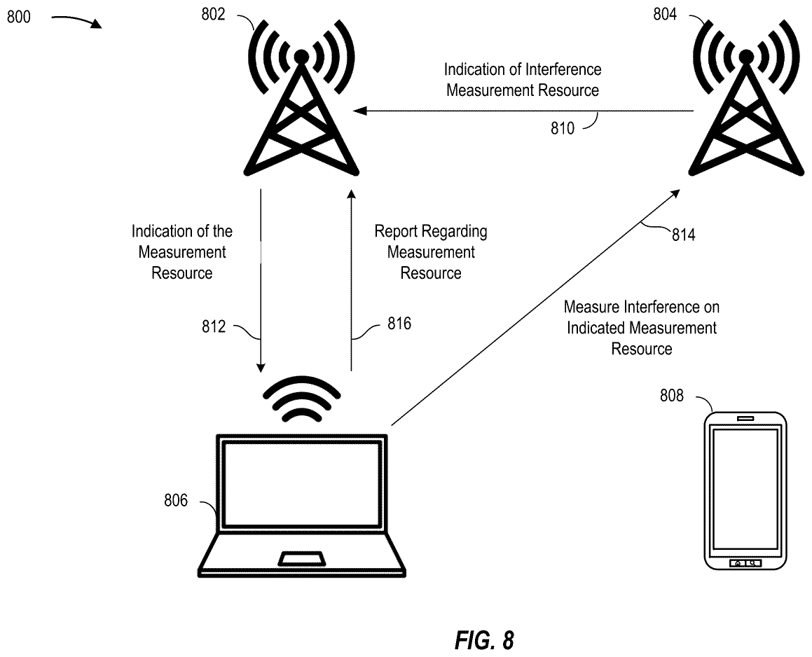

FIG. 8 is a diagram illustrating an example process 800 of measuring interference at a CPE from a neighbor network entity to support interference mitigation at the CPE. More specifically, process 800 enables a first (serving) network entity 802 to indicate a measurement resource to a CPE 806 that is usable to measure interference at CPE 806 from a neighboring second network entity 804. CPE 806 may then send first network entity 802 a report regarding the indicated measurement resource to provide the first network entity 802 or second network entity 804 with information to enable performance of actions to mitigate interference at the CPE, thereby improving performance of the CPE and/or the first or second network entity.

In some aspects, the first and second network entities 802, 804 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the CPE 806 may be an example of UE 104 depicted and described with respect to FIG. 1 or the UE 304 depicted and described with respect to FIG. 3. However, in other aspects, CPE 806 may be another type of wireless communications device and network entities 802, 804 may be another type of network entity or network node, such as those described herein.

In aspects, first network entity 802 and second network entity 804 may be configured to operate in one or more of a full duplex mode, a sub-band full duplex mode, a single frequency full duplex mode, or a time division duplex mode, such as described above.

At 810, second network entity 804 sends, and first network entity 802 receives, an indication of a measurement resource. In some examples, first network entity 802 and second network entity 804 may exchange the measurement resource to measure inter-gNB cross-link interference. For example, the measurement resource may be an inter-gNB cross-link interference SSB measurement resource that can be used to measure reference signal received power (RSRP), reference signal received quality (RSRQ), or signal-to-interference-plus-noise ratio (SINR). In other examples, the indicated measurement resource may be a non-zero power channel state information (CSI) reference signal measurement resource usable to measure inter-gNB cross-link interference. In aspects, the indicated measurement resource may include any configured or periodic measurement resource usable to measure interference between the CPE and a network entity, such as a downlink channel or reference signal measurement resource, a semi persistently scheduled resource for a physical downlink shared channel (PDSCH), a CSI-RS configured for interference measurements, or the like.

The second network entity 804 may send the indication of the measurement resource to first network entity 802 via any suitable interface, such as an Xn signaling interface. In some cases, second network entity 804 may send the indication of the measurement resource to first network entity 802 using an F1 Application Protocol (F1AP) for signaling between one or more CUs and DUs. In some examples, if first network entity 802 and second network entity 804 belong to the same CU, then second network entity 804 may send F1AP signaling to the CU to enable the CU to send F1AP signaling to first network entity 802. In other examples, first network entity 802 may belong to a first CU₁ and second network entity 804 may belong to a second CU₂. Second network entity 804 may send F1AP signaling to CU₂, such that CU₂ may send Xn signaling to CU₁, and CU₁ may send F1AP signaling to first network entity 802.

At 812, first network entity 802 sends an indication of the measurement resource (originating from second network entity 804) to CPE 806. In some examples, measurement resource may be indicated by first network entity 802 to CPE 806 via RRC signaling or a MAC-CE. The indication of the measurement resource may further include an identifier that indicates the second network entity 804. For example, the identifier may include a physical cell identifier (PCI) or a cell ID.

At 814, CPE 806 performs a measurement of interference between CPE 806 and neighboring second network entity 804 on the indicated measurement resource. For example, CPE 806 perform a measurement of interference between CPE 806 and neighboring second network entity 804 using an indicated SSB measurement resource at a given frequency, measuring an RSRP of −70 dBm, and a SINR of 3 dB. Second network entity 804 may transmit an SSB on the SSB measurement resource.

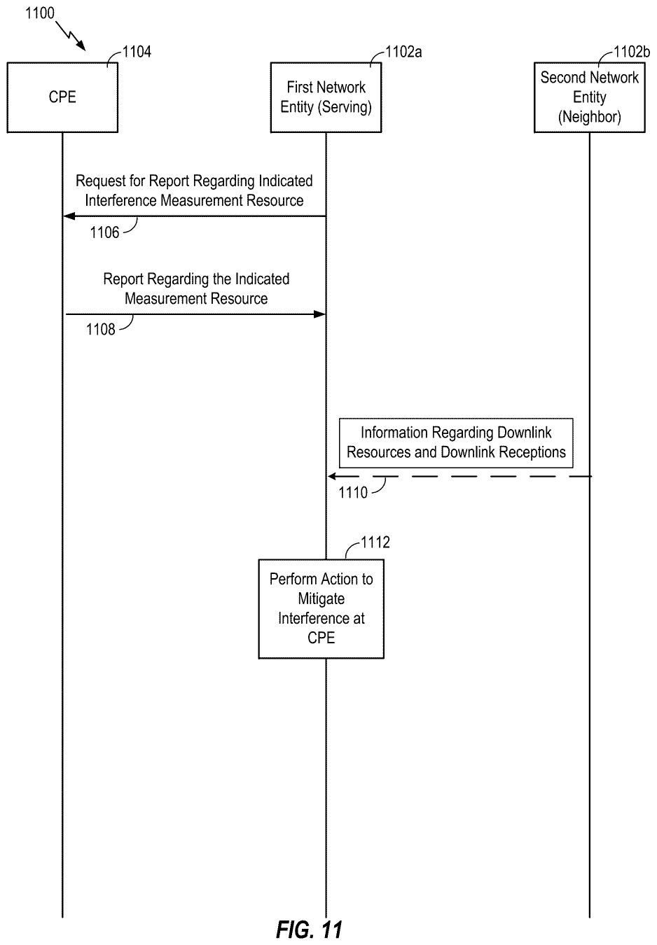

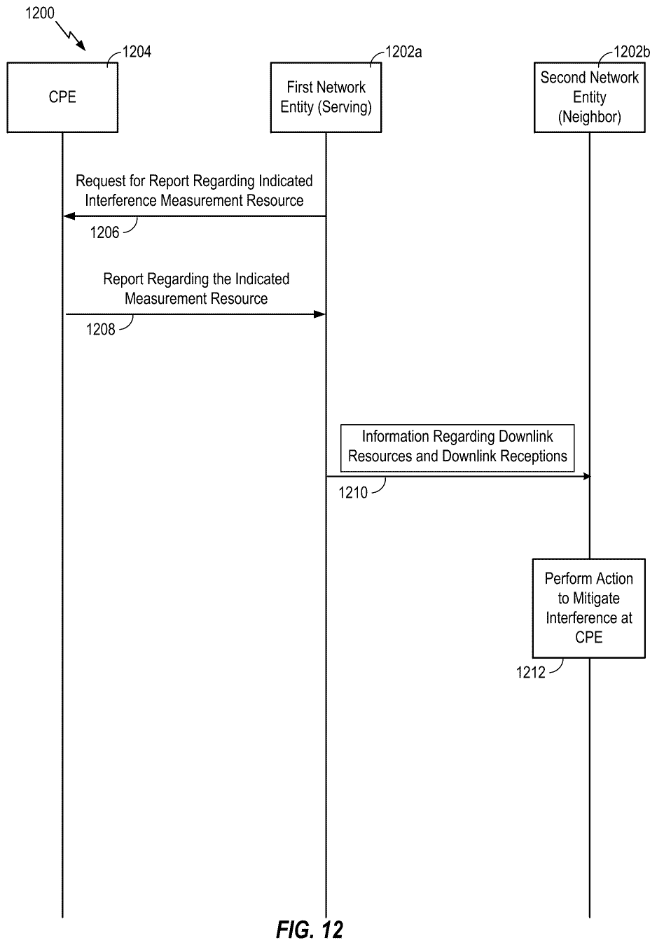

At 816, CPE 806 sends first network entity 802 a report regarding the measurement resource. Returning to the example above, the report may indicate the measured RSRP of −70 dBM and the measured SINR of 3 dB measured on the SSB resource, suggesting high interference and poor signal quality between CPE 806 and second network entity 804 on the identified resource. In some examples, CPE 806 may send the report regarding the measurement resource in accordance with a periodic reporting configuration or a semi-persistent reporting configuration. In other examples, CPE 806 may send the report regarding the measurement resource in accordance with an aperiodic triggering reporting configuration. For example, CPE 806 may receive, from first network entity 802, a trigger via one of uplink control information (UCI) or a MAC-CE to trigger a transmission of the report regarding the measurement resource. In some examples, the report regarding the measurement resource includes a RSRP or RSSI configured for interference measurements. In some cases, the report regarding the measurement resource is sent in accordance with a CSI reporting configuration. The report regarding the measurement resource thus provides first network entity 802 with information to enable performance of actions to mitigate interference at the CPE (as will be described in greater detail below with reference to FIGS. 11-12), thereby improving performance of the CPE and/or the first or second network entity.

### Example Signaling to Measure Neighbor Network Entity Interference at a User Equipment for Interference Mitigation

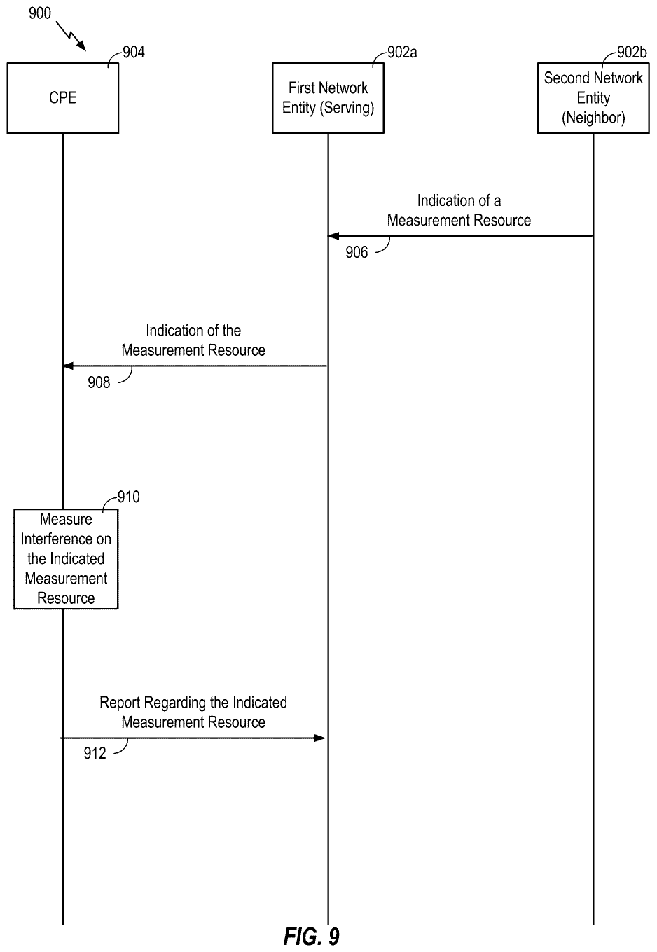

FIG. 9 depicts a process flow 900 for communications in a network between a first network entity 902a, a second network entity 902b, and a CPE 904. In certain aspects, signaling in accordance with process flow 900 is usable to provide CPE 904 with an indication of a measurement resource usable to measure interference at CPE 904 from second network entity 902b. CPE 904 may then send first network entity 902a a report regarding the indicated measurement resource to provide the first network entity 902a with information that may be leveraged by first network entity 902a or second network entity 902b to perform actions to mitigate interference at the CPE. Thus, process flow 900 provides signaling for enabling CPE 904 to measure and accurately report information usable by network entities 902a, 902b to perform actions to mitigate interference, thereby providing the technical benefit of improving performance of the CPE and/or the first or second network entity.

In some aspects, the first and second network entities 902a, 902b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the CPE 904 may be an example of UE 104 depicted and described with respect to FIG. 1 or the UE 304 depicted and described with respect to FIG. 3. However, in other aspects, CPE 904 may be another type of wireless communications device and network entities 902a, 902b may be another type of network entity or network node, such as those described herein. Note that any operations or signaling illustrated with dashed lines may indicate that that operation or signaling is an optional or alternative example.

At 906, second network entity 902b sends, to first network entity 902a, an indication of a measurement resource. In some cases, the indicated measurement resource is optionally usable to measure inter-gNB interference between second network entity 902b and first network entity 902a. For example, first network entity 902a may use the measurement resource to measure interference from second network entity 902b. The indication of the measurement resource may be sent from second network entity 902b to first network entity 902a using similar means as described above at 810 of process 800 with reference to FIG. 8.

At 908, first network entity 902a sends, to CPE 904, an indication of the measurement resource. The indicated measurement resource corresponds to the measurement resource sent to first network entity 902a by second network entity 902b at 906. First network entity 902a may send the indication of the measurement resource to CPE 904 using similar means as described above at 812 of process 800 with reference to FIG. 8.

In some aspects, the indication of the measurement resource may include a receive (Rx) beam configuration. For example, first network entity 902a may provide one or more transmission configuration indication (TCI) state to CPE 904. A TCI state may include a set of parameters that define a spatial reception configuration for CPE 904. The spatial reception configuration may indicate an Rx beam for receiving a transmission corresponding to the indicated measurement resource. In some aspects, first network entity 902a may configure a plurality of TCI states for the measurement resource, such that the CPE 904 can measure interference on multiple different receive beams, thereby enabling beam-specific interference mitigation.

At 910, CPE 904 measures interference on the indicated measurement resource. In some cases, CPE 904 measures interference on the indicated measurement using an Rx beam configured by first network entity 902a. For example, CPE 904 may use a TCI state configured by first network entity 902a, as described above.

At 912, CPE 904 sends, to first network entity 902a, a report regarding the indicated measurement resource. CPE 904 may send the report regarding the indicated measurement resource using similar means as described above at 816 of process 800 with reference to FIG. 8.

Example Signaling of Rules to Handle Collisions at a User Equipment Between an Indicated Measurement Resource and a Conflicting Transmission or Reference Signal

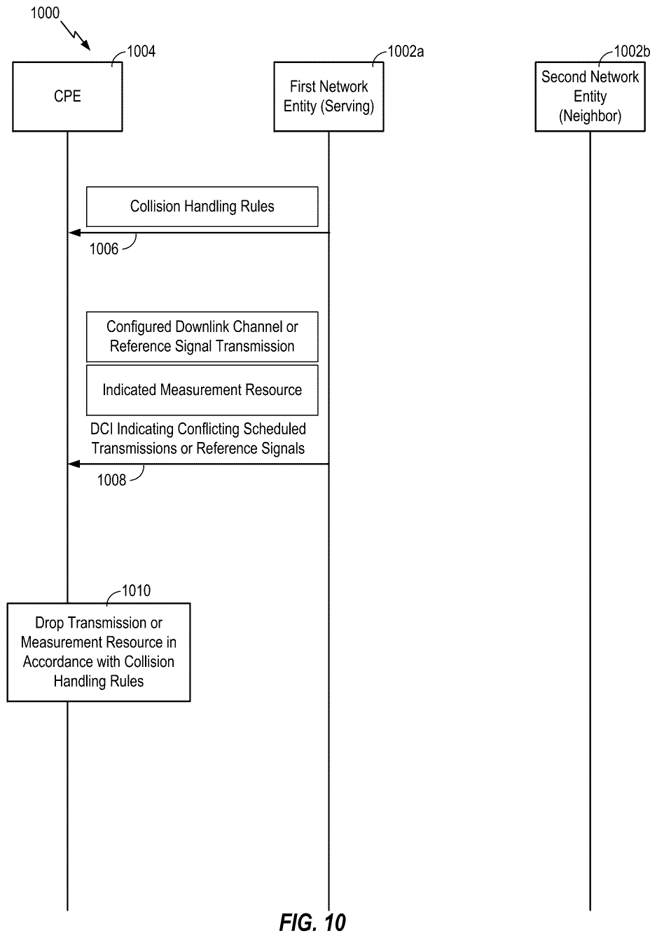

FIG. 10 depicts a process flow 1000 for communications in a network between a first network entity 1002a, a second network entity 1002b, and a CPE 1004. In certain aspects, signaling in accordance with process flow 1000 may enable first network entity 1002a to configure CPE 1004 with collision handling rules to handle conflicts between configured downlink/uplink channel or reference signal transmissions and an indicated measurement resource. The configured collision handling rules are thus usable to determine a transmission or measurement to drop in the presence of scheduling conflicts, providing the technical benefit of improving resource scheduling efficiency and interference mitigation.

In some aspects, the first and second network entities 1002a, 1002b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the CPE 1004 may be an example of UE 104 depicted and described with respect to FIG. 1 or the UE 304 depicted and described with respect to FIG. 3. However, in other aspects, CPE 1004 may be another type of wireless communications device and network entities 1002a, 1002b may be another type of network entity or network node, such as those described herein. Note that any operations or signaling illustrated with dashed lines may indicate that that operation or signaling is an optional or alternative example.

At 1006, first network entity 1002a sends, to CPE 1004, collision handling rules. For example, first network entity 1002a may configure CPE 1004 with a set of collision handling rules usable by CPE 1004 to determine a given transmission to be dropped when one or more configured transmissions or references signals conflict with an indicated measurement resource for measuring interference at second network entity 1002b. As used herein, “dropping” refers to a UE (e.g. a CPE) canceling a scheduled transmission or reception, such that the transmission is not sent or received by the UE. For example, a CPE may drop a configured uplink, downlink, or reference signal transmission or reception that is scheduled to be transmitted or received. In some aspects, the collision handling rules may be pre-configured at CPE 1004. For example, a collision handling rule may be provided in a wireless communication specification, and 1006 may be omitted from process flow 1000.

In some aspects, CPE 1004 may be configured to drop a configured downlink channel or reference signal transmission based on a first priority level of a downlink channel or reference signal associated with the configured downlink channel or reference signal transmission and a second priority level of the indicated measurement resource. For example, the CPE 1004 may be configured with a priority level for a downlink channel or a reference signal, or may be configured with a priority level for the configured downlink channel or reference signal transmission (e.g., for downlink data transmitted via the downlink channel). CPE 1004 may compare the priority level for the configured downlink channel or reference signal and a priority level for the measurement resource. CPE 1004 may drop the configured downlink channel or reference signal (e.g., may not receive the configured downlink channel or reference signal) if the priority level of the configured downlink channel or reference signal indicates a lower priority than the priority level of the measurement resource.

Additionally, or alternatively, may be configured to drop a configured uplink channel or reference signal transmission based on a first priority level of an uplink channel or reference signal associated with the configured uplink channel or reference signal transmission and a second priority level of the indicated measurement resource. For example, CPE 1004 may be configured with a priority level for an uplink channel or a reference signal, or may be configured with a priority level for the configured uplink channel or reference signal transmission (e.g., for downlink data transmitted via the downlink channel). CPE 1004 may compare the priority level for the configured uplink channel or reference signal and a priority level for the measurement resource. CPE 1004 may drop the configured uplink channel or reference signal (e.g., may not receive the configured downlink channel or reference signal) if the priority level of the configured uplink channel or reference signal indicates a lower priority than the priority level of the measurement resource..

In other aspects, CPE 1004 may be configured to drop a configured downlink channel or reference signal transmission based on a channel type of a downlink channel or reference signal associated with the configured downlink channel or reference signal transmission. Accordingly, if the configured downlink channel transmission conflicts with the indicated measurement resource, the CPE will drop the configured downlink transmission based on the lower priority level of the associated channel type as compared to the higher priority level of the measurement resource. CPE 1004 may be configured with similar collision handling rules for determining whether to drop a configured uplink channel or reference signal transmission that conflicts with an indicated resource measurement usable to measure interference at CPE 1004 from second network entity 1002b based on a channel type of the uplink channel or reference signal associated with the configured uplink channel or reference signal transmission.

In some examples, CPE 1004 may drop a configured downlink channel or reference signal transmission based on an indication received from first network entity 1002a. For example, first network entity 1002a may send, to CPE 1004, and indication to drop a configured reference signal transmission that conflicts with a measurement resource. Similarly, in some cases, CPE 1004 may drop a configured uplink channel or reference signal transmission based on an indication received from first network entity 1002a.

In other examples, CPE 1004 may be configured to drop an indicated measurement resource if there is a downlink channel transmission or reference signal that has been dynamically scheduled on conflicting downlink resources. In some cases, CPE 1004 may be configured to drop a measurement resource if there is an uplink channel transmission or reference signal that has been dynamically scheduled on conflicting downlink resources.

At 1008, CPE 1004 receives, from first network entity 1002a, DCI indicating conflicting scheduled transmissions or reference signals. For example, the DCI may reflect that a received indication regarding a measurement resource usable to measure interference at CPE 1004 from second network entity 1002b conflict with a configured downlink channel or reference signal transmission.

At 1010, CPE 1004 drops either the configured transmission or the indicated measurement resource in accordance with the collision handling rules provided to the CPE as described above at 1006.

Accordingly, process flow 1000 enables CPE 1004 to be configured by first network entity 1002a with collision handling rules to enable CPE 1004 to determine whether to drop an indicated measurement resource or a conflicting configured transmission or reference signal. This provides the technical benefit of improving resource scheduling efficiency and interference mitigation at CPE 1004 and network entities 1002a, 1002b.

### Example Signaling of a Report Regarding an Indicated Measurement Resource to Support Interference Mitigation at a Cpe

FIG. 11 depicts a process flow 1100 for communications in a network between a first network entity 1102a, a second network entity 1102b, and a CPE 1104. In certain aspects, signaling in accordance with process flow 1100 may enable first network entity 1102a to receive a report regarding the measurement resource used to measure interference at CPE 1104 from the second network entity 1102b. First network entity 1002a may then perform one or more actions based on the received report to mitigate interference experienced by CPE 1104, thereby improving performance of CPE 1104 and/or the first or second network entities 1102a, 1102b.

In some aspects, the first and second network entities 1102a, 1102b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the CPE 1104 may be an example of UE 104 depicted and described with respect to FIG. 1 or the UE 304 depicted and described with respect to FIG. 3. However, in other aspects, CPE 1104 may be another type of wireless communications device and network entities 1102a, 1102b may be another type of network entity or network node, such as those described herein. Note that any operations or signaling illustrated with dashed lines may indicate that that operation or signaling is an optional or alternative example.

At 1106, first network entity 1002a sends, to CPE 1104, a request for a report regarding a measurement resource. CPE 1104 may receive the indication of the measurement resource from first network entity 1002a, as described with respect to 812 of FIGS. 8 and 912 of FIG. 9. For example, CPE 1104 may receive, from first network entity 1002a, an indication of a measurement resource via RRC signaling. The request for the report regarding the indicated measurement resource may similarly be provided via RRC signaling. As discussed above, in some examples, the request for the report further includes a trigger including one of UCI or a MAC-CE to trigger a transmission of the report regarding the measurement resource, such as described with respect to 816 of FIG. 8.

At 1108, CPE 1104 sends a report regarding the indicated measurement resource to first network entity 1102a. CPE 1104 may send the report regarding the indicated measurement resource as described at 816 of FIGS. 8 and 912 of FIG. 9.

At 1110, second network entity 1102b optionally sends, to first network entity 1102a, information regarding configured downlink resources or downlink receptions of second network entity 1102b. For example, second network entity 1102b may use an Xn signaling interface to provide the information regarding configured downlink resources or downlink receptions. The information provides first network entity 1102a with an understanding of which configured downlink resources are being used at second network entity 1102b. First network entity 1102a may then use the information to perform actions to mitigate interference at CPE 1104, as described below.

At 1112, first network entity 1102a performs one or more actions to mitigate interference at CPE 1104. In some examples, based on the received report at 1108, first network entity 1102a may configure a receiving beam associated with lower than a threshold interference for downlink reception at CPE 1104. For example, the report may indicate interference levels associated with one or more receiving beams, and first network entity 1102a may select a receiving beam according to the interference levels.

In some aspects, first network entity 1102a may schedule one or more transmissions for the CPE on a second downlink resource separate from a configured downlink resource or downlink reception at second network entity 1102b. For example, first network entity 1102a may use the information signaled at 1110 to identify configured downlink resources or receptions. In some cases, first network entity 1102a may perform actions to mitigate interference at CPE 1104 by sending an indication to CPE 1104 to disable or change a receiving beam based on the first downlink resource that corresponds to interference above a threshold.

In other cases, first network entity 1102a may perform actions to mitigate interference at CPE 1104 by sending one or more transmissions with an increased transmission power for one or more downlink resources associated with the first downlink resource. For example, first network entity 1102a may increase its transmission power by a number of decibels (dB) to mitigate interference at CPE 1104 on the first downlink resource by improving signal quality.

Accordingly, process flow 1100 enables first network entity 1102a to perform actions to mitigate interference at CPE 1104 based on a received report regarding an indicated measurement resource, and optionally based on exchanged information from second network entity 1102b. Process flow 1100 thus provides the technical benefit of increasing reliability and performance of CPE 1104 and first and second network entities 1102a, 1102b.

FIG. 12 depicts a process flow 1200 for communications in a network between a first network entity 1202a, a second network entity 1202b, and a CPE 1204. In certain aspects, signaling in accordance with process flow 1200 may enable first network entity 1202a to receive a report regarding the measurement resource used to measure interference at CPE 1204 from second network entity 1202b. First network entity 1202a may then exchange information, such as based on the received report regarding the measurement resource, with second network entity 1202b. Second network entity 1202b may then perform one or more actions based on the received information to mitigate interference experienced by CPE 1204, thereby providing the technical benefit of reducing latency and increasing throughput at CPE 1204 and/or the first or second network entities 1102a, 1102b.

In some aspects, the first and second network entities 1202a, 1202b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the CPE 1204 may be an example of UE 104 depicted and described with respect to FIG. 1 or the UE 304 depicted and described with respect to FIG. 3. However, in other aspects, CPE 1204 may be another type of wireless communications device and network entities 1202a, 1202b may be another type of network entity or network node, such as those described herein. Note that any operations or signaling illustrated with dashed lines may indicate that that operation or signaling is an optional or alternative example.

At 1206, first network entity 1202a sends, to CPE 1204, a request for a report regarding a measurement resource. CPE 1204 may receive the indication of the measurement resource from first network entity 1202a, as described with respect to 812 of FIGS. 8 and 912 of FIG. 9. For example, CPE 1204 may receive, from first network entity 1002a, an indication of a measurement resource via RRC signaling. The request for the report regarding the indicated measurement resource may similarly be provided via RRC signaling. As discussed above, in some examples, the request for the report further includes a trigger including one of UCI or a MAC-CE to trigger a transmission of the report regarding the measurement resource, such as described with respect to 816 of FIG. 8. First network entity 1202a may send the request to CPE 1204 using similar means as step 1106 of process flow 1100 described above with reference to FIG. 11.

At 1208, CPE 1204 sends, to first network entity 1202a the report regarding the indicated measurement resource. CPE 1204 may send the report regarding the indicated measurement resource using similar means as at 816 of process 800 described above with reference to FIGS. 8 and 912 of FIG. 9.

At 1210, first network entity 1202a sends, to second network entity 1202b, information regarding configured downlink resources or downlink receptions of first network entity 1202a. First network entity 1202a may send the second information regarding downlink resource and downlink receptions using similar means as step 1110 of process flow 1100 described above with reference to FIG. 11.

At 1212, second network entity 1202b performs one or more actions to mitigate interference at CPE 1204, such as based on the information received from first network entity 1202a at 1210. For example, the information received from first network entity 1202a may indicate that a first downlink beam is associated with a measurement of interference. To mitigate interference at CPE 1204, second network entity 1202b may switch, based on the received information, from using the first downlink beam associated with the measurement of interference to a second downlink beam, thereby mitigating interference at CPE 1204 based on use of the first downlink beam.

In other examples, second network entity 1202b may mitigate interference at CPE 1204 by reducing, based on the received information from first network entity 1202a, a transmit power for one or more transmissions on one or more downlink resources. For example, second network entity 1202b may reduce transmit power by a certain number of dBs on one or more downlink resources corresponding to a measurement of interference.

Accordingly, process flow 1200 enables second network entity 1202b to leverage information provided by first network entity 1202a at 1210 to perform actions to mitigate interference at CPE 1204. Process flow 1200 thus provides the technical benefit of increasing reliability and performance by reducing latency and increasing throughput of CPE 1204 and first and second network entities 1202a, 1202b.

Note that the process flow illustrated in FIGS. 9-12 are examples of techniques for measuring neighbor network entity interference at a user equipment for interference mitigation, and aspects of the present disclosure may be performed in various manners via alternative or additional signaling and/or operations. In certain aspects, the operations and/or signaling of FIGS. 9-12 may occur in an order different from that described or depicted, and various actions, operations, and/or signaling may be added, omitted, or combined.

### Example Operations of a CPE

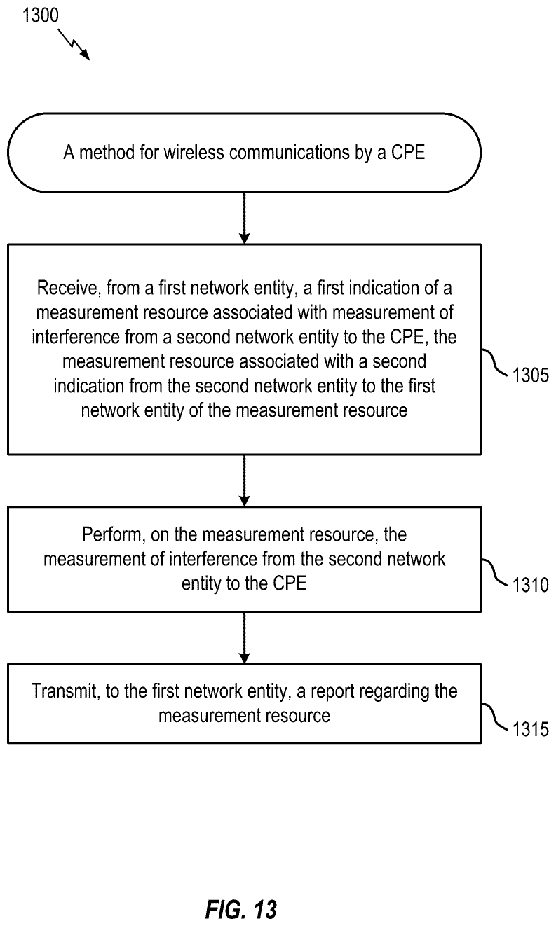

FIG. 13 shows a method 1300 for wireless communications by a CPE, such as UE 104 of FIG. 1 or UE 304 of FIG. 3.

Method 1300 begins at block 1305 with receiving, from a first network entity, a first indication of a measurement resource associated with measurement of interference from a second network entity to the CPE, the measurement resource associated with a second indication from the second network entity to the first network entity of the measurement resource. For example, the receiving of the first indication of the first measurement resource associated with measurement of interference from the second network entity to the CPE could correspond to 812 of FIG. 8 or 908 of FIG. 9. Method 1300 thus provides common understanding between a CPE and a first network entity of how interference between a CPE and a second neighbor entity is to be measured and reported.

Method 1300 then proceeds to block 1310 with performing, on the measurement resource, the measurement of interference from the second network entity to the CPE. For example, the performing of the measurement of interference from the second network entity to the CPE could correspond to 814 of FIG. 8 or 910 of FIG. 9. Method 1300 thus enables CPE to measure interference from a second network entity using a measurement resource provided by a first network entity.

Method 1300 then proceeds to block 1315 with transmitting, to the first network entity, a report regarding the measurement resource. For example, the transmitting of the report regarding the measurement resource may correspond to 816 of FIGS. 8, 912 of FIGS. 9, 1108 of FIG. 11, or 1208 of FIG. 12. Method 1300 provides signaling for enabling a CPE to measure and accurately report information usable by network entities to perform actions to mitigate interference, thereby providing the technical benefit of reducing latency and increasing throughput at the CPE and/or the first or second network entity.

In some aspects, the measurement resource comprises an inter-gNB CLI SSB measurement resource.

In some aspects, the measurement resource comprises a periodic non-zero power CSI reference signal measurement resource.

In some aspects, the measurement resource comprises a downlink channel reference signal resource.

In some aspects, the measurement resource comprises a semi persistently scheduled resource for a physical downlink shared channel.

In some aspects, the first indication comprises an identifier that indicates the second network entity.

In some aspects, the first indication of the measurement resource is received via one of RRC signaling or a MAC-CE.

In some aspects, the measurement resource comprises at least one of: a periodic resource, a semi-persistently scheduled resource, or an aperiodic resource.

In some aspects, the measurement resource conflicts with a configured downlink channel or reference signal transmission, and wherein the method 1300 further comprises dropping the configured downlink channel or reference signal transmission.

In some aspects, the configured downlink channel or reference signal transmission is dropped based on a first priority level of a downlink channel or reference signal associated with the configured downlink channel or reference signal transmission, wherein the first priority level of the downlink channel or reference signal is lower than a second priority level of the measurement resource.

In some aspects, the configured downlink channel or reference signal transmission is dropped based on a channel type of a downlink channel or reference signal associated with the configured downlink channel or reference signal transmission.

In some aspects, the configured downlink channel or reference signal transmission is dropped based on a third indication from the first network entity.

In some aspects, the measurement resource is a first measurement resource, wherein the method 1300 further comprises: receiving a third indication of a second measurement resource associated with a fourth indication from the second network entity to the first network entity of the second measurement resource, wherein the second measurement resource conflicts with a configured downlink channel or reference signal transmission, and wherein the method 1300 further comprises dropping the second measurement resource.

In some aspects, the measurement resource is a first measurement resource, wherein the method 1300 further comprises: receiving a third indication of a second measurement resource associated with a fourth indication from the second network entity to the first network entity of the second measurement resource, wherein the second measurement resource conflicts with a dynamically scheduled downlink channel or reference signal transmission, and wherein the method 1300 further comprises dropping the second measurement resource.

In some aspects, the measurement resource conflicts with a configured uplink channel or reference signal transmission, and wherein the method 1300 further comprises dropping the configured uplink channel or reference signal transmission.

In some aspects, the configured uplink channel or reference signal transmission is dropped based on a first priority level of an uplink channel or reference signal associated with the configured uplink channel or reference signal transmission, wherein the first priority level of the uplink channel or reference signal is lower than a second priority level of the measurement resource.

In some aspects, the configured uplink channel or reference signal transmission is dropped based on a channel type of an uplink channel or reference signal associated with the configured uplink channel or reference signal transmission.

In some aspects, the configured uplink channel or reference signal transmission is dropped based on a third indication from the first network entity.

In some aspects, the measurement resource is a first measurement resource, wherein the method 1300 further comprises: receiving a third indication of a second measurement resource associated with a fourth indication from the second network entity to the first network entity of the second measurement resource, wherein the second measurement resource conflicts with a configured uplink channel or reference signal transmission, and wherein the method 1300 further comprises dropping the second measurement resource.

In some aspects, the measurement resource is a first measurement resource, wherein the method 1300 further comprises: receiving a third indication of a second measurement resource associated with a fourth indication from the second network entity to the first network entity of the second measurement resource, wherein the second measurement resource conflicts with a dynamically scheduled uplink channel or reference signal transmission, and wherein the method 1300 further comprises dropping the second measurement resource.

In some aspects, the report regarding the measurement resource is in accordance with a periodic reporting configuration.

In some aspects, the report regarding the measurement resource is in accordance with a semi-persistent reporting configuration.

In some aspects, the report regarding the measurement resource is in accordance with an aperiodic triggering reporting configuration.

In some aspects, method 1300 further includes receiving, from the first network entity, a trigger comprising one of UCI or a MAC-CE to trigger a transmission of the report regarding the measurement resource, wherein sending the report comprises sending the report in association with the trigger.

In some aspects, the report regarding the measurement resource comprises a reference signal received power measurement.

In some aspects, the report regarding the measurement resource comprises a received signal strength indicator measurement.

In some aspects, the report regarding the measurement resource is in accordance with a channel state information reporting configuration.

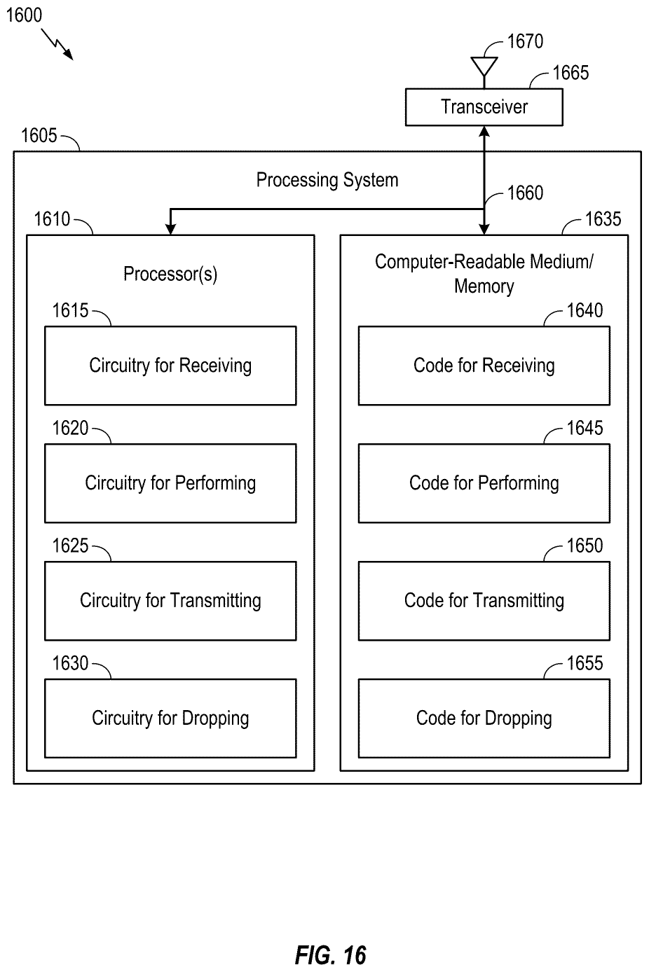

In some aspects, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative operations are possible consistent with this disclosure.

### Example Operations of a Network Entity

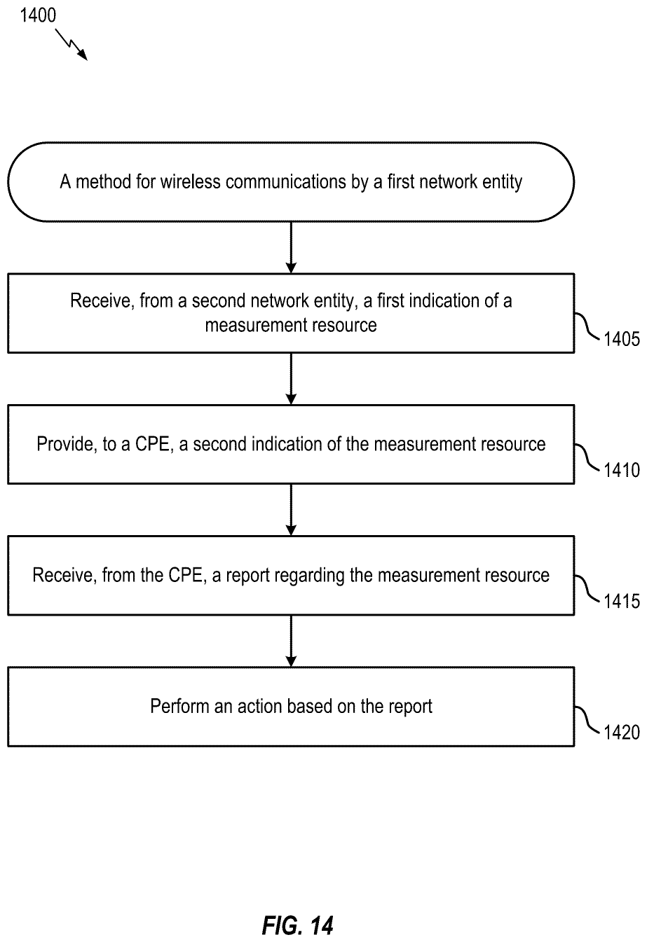

FIG. 14 shows a method 1400 for wireless communications by a first network entity, such as BS 102 of FIG. 1, a first network entity 300 or second network entity 302 of FIG. 3, or a disaggregated base station as discussed with respect to FIG. 2.

Method 1400 begins at block 1405 with receiving, from a second network entity, a first indication of a measurement resource. For example, the receiving of the first indication of the measurement resource could correspond to 810 of FIG. 8 or 906 of FIG. 9.

Method 1400 then proceeds to block 1410 with providing, to a CPE, a second indication of the measurement resource. For example, the providing of the second indication of the measurement resource could correspond to 812 of FIG. 8 or 908 of FIG. 9.

Method 1400 then proceeds to block 1415 with receiving, from the CPE, a report regarding the measurement resource. For example, the receiving of the report regarding the measurement resource could correspond to 816 of FIGS. 8, 912 of FIGS. 9, 1108 of FIG. 11, or 1208 of FIG. 12.

Method 1400 then proceeds to block 1420 with performing an action based on the report. For example, the performing of the action based on the report could correspond to 1112 of FIG. 11 or 1212 of FIG. 12. Method 1400 thus enables a network entity to perform actions to mitigate interference at a CPE based on a received report regarding an indicated measurement resource. This provides the technical benefit of reducing latency and increasing throughput at the CPE and/or the first network entity.

In some aspects, the first network entity operates in a full duplex mode.

In some aspects, the first network entity operates in a sub-band full duplex mode.

In some aspects, the first network entity operates in a single frequency full duplex mode.

In some aspects, the first network entity operates in a time division duplex mode.

In some aspects, the measurement resource is associated with measurement of interference from a second network entity to the CPE.

In some aspects, the second network entity indicates the measurement resource to the first network entity using an Xn signaling interface.

In some aspects, the second network entity indicates the measurement resource to the first network entity using an F1AP signaling interface.

In some aspects, the report regarding the measurement resource is in accordance with a periodic reporting configuration.

In some aspects, the report regarding the measurement resource is in accordance with a semi-persistent reporting configuration.

In some aspects, the report regarding the measurement resource is in accordance with an aperiodic triggering reporting configuration.

In certain aspects, method 1400 further includes sending, to the CPE, a trigger comprising one of UCI or a MAC-CE to trigger a transmission of the report regarding the measurement resource, wherein block 1415 includes receiving the report in association with the trigger.

In some aspects, the report regarding the measurement resource comprises a reference signal received power measurement.

In some aspects, the report regarding the measurement resource comprises a received signal strength indicator measurement.

In some aspects, the report regarding the measurement resource is in accordance with a channel state information reporting configuration.

In some aspects, the measurement resource comprises an inter-gNB CLI SSB measurement.

In some aspects, the measurement resource comprises a periodic non-zero power CSI reference signal measurement.

In some aspects, the measurement resource comprises a downlink channel reference signal.

In some aspects, the measurement resource comprises a semi persistent scheduling resource on a physical downlink shared channel.

In some aspects, the first indication comprises an identifier that indicates the second network entity.

In some aspects, block 1420 includes configuring a receiving beam, associated with lower than a threshold interference, for downlink reception at the CPE.

In certain aspects, method 1400 further includes receiving, from the second network entity, information indicating a first downlink resource of the second network entity.

In some aspects, block 1420 includes scheduling one or more transmissions for the CPE on a second downlink resource separate from the first downlink resource.

In some aspects, block 1420 includes sending an indication to the CPE to disable a downlink beam based on the first downlink resource.

In some aspects, block 1420 includes sending, to the CPE, one or more transmissions with an increased transmission power for one or more downlink resources associated with the first downlink resource.

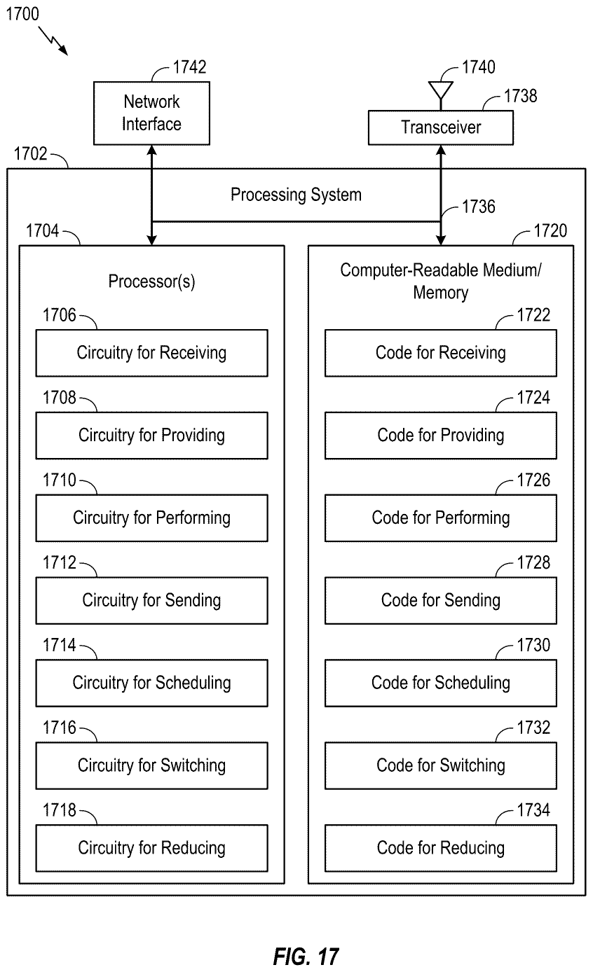

In some aspects, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative operations are possible consistent with this disclosure.

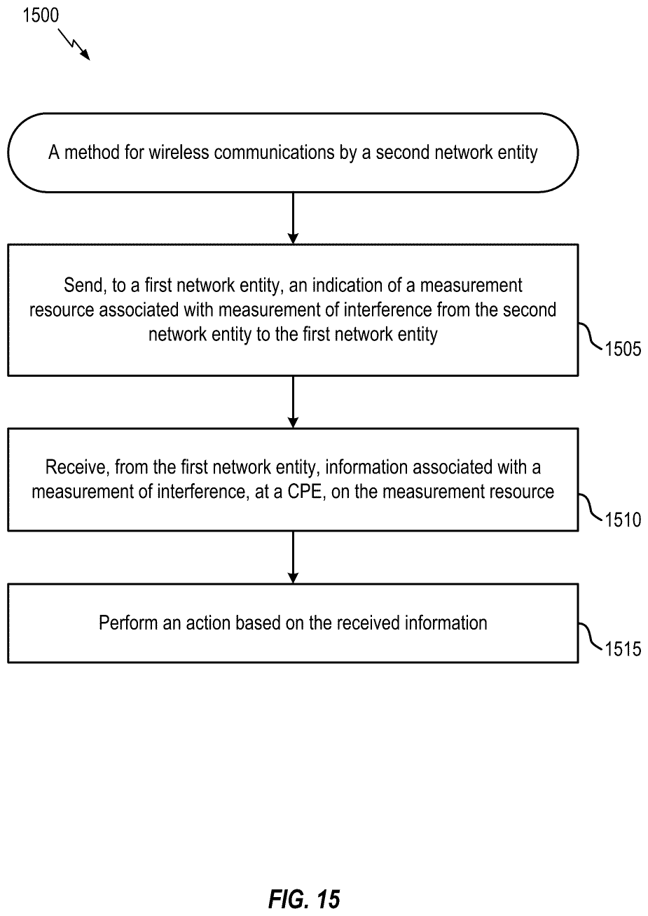

FIG. 15 shows a method 1500 for wireless communications by a second network entity, such as BS 102 of FIG. 1, a first network entity 300 or second network entity 302 of FIG. 3, or a disaggregated base station as discussed with respect to FIG. 2.

Method 1500 begins at block 1505 with sending, to a first network entity, an indication of a measurement resource associated with measurement of interference from the second network entity to the first network entity. For example, the sending of the indication of the measurement resource associated with measurement of interference from the second network entity to the first network entity could correspond to 810 of FIG. 8 or 906 of FIG. 9.

Method 1500 then proceeds to block 1510 with receiving, from the first network entity, information associated with a measurement of interference, at a CPE, on the measurement resource. For example, the receiving of the information associated with the measurement of interference could correspond to 1210 of FIG. 12.

Method 1500 then proceeds to block 1515 with performing an action based on the received information. For example, the performing of the action based on the received information could correspond to 1212 of FIG. 12. Method 1500 enables second network entity to leverage information provided by a first network entity to perform actions to mitigate interference at a CPE. This provides the technical benefit of increasing reliability and performance by reducing latency and increasing throughput at the CPE and/or at the first and second network entities.

In some aspects, block 1515 includes switching, based on the received information, from a first downlink beam associated with the measurement of interference to a second downlink beam.

In some aspects, block 1515 includes reducing, based on the received information, a transmit power for one or more transmissions on one or more downlink resources.

In some aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Communications Devices

FIG. 16 depicts aspects of an example communications device 1600 configured for wireless communications. In some aspects, communications device 1600 is a CPE or a user equipment, such as UE 104 described above with respect to FIG. 1 or UE 304 described with respect to FIG. 3.

The communications device 1600 includes a processing system 1605 coupled to a transceiver 1665 (e.g., a transmitter and/or a receiver). The transceiver 1665 is configured to transmit and receive signals for the communications device 1600 via an antenna 1670, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1635. In various aspects, the one or more processors 1610 may be representative of the one or more processors 318 described with respect to FIG. 3. The one or more processors 1610 are coupled to a computer-readable medium/memory 1635 via a bus 1660. In some aspects, the computer-readable medium/memory 1635 may be representative of the one or more memories 320 described with respect to FIG. 3. The computer-readable medium/memory 1635 is a non-transitory computer-readable medium/memory. In certain aspects, the computer-readable medium/memory 1635 is configured to store instructions (e.g., computer-executable code), that when executed by the one or more processors 1610, cause the one or more processors 1610 to perform the method 1300 described with respect to FIG. 13, or any aspect related to it, including any operations described in relation to FIG. 13. Note that reference to a processor performing a function of communications device 1600 may include one or more processors performing that function of communications device 1600, such as in a distributed fashion.

In the depicted example, computer-readable medium/memory 1635 stores code (e.g., executable instructions), including code for receiving 1640, code for performing 1645, code for transmitting 1650, and code for dropping 1655. Processing of the code 1640-1655 may enable and cause the communications device 1600 to perform the method 1300 described with respect to FIG. 13, or any aspect related to it. For instance, in some aspects, code for receiving 1640 includes code for receiving, from a first network entity, a first indication of a measurement resource associated with measurement of interference from a second network entity to the CPE, the measurement resource associated with a second indication from the second network entity to the first network entity of the measurement resource. In some aspects, code for performing 1645 includes code for performing, on the measurement resource, the measurement of interference from the second network entity to the CPE. In some aspects, code for transmitting 1650 includes code for transmitting, to the first network entity, a report regarding the measurement resource.

The one or more processors 1610 include circuitry configured to implement (e.g., execute) the code stored in the computer-readable medium/memory 1635, including circuitry for receiving 1615, circuitry for performing 1620, circuitry for transmitting 1625, and circuitry for dropping 1630. Processing with circuitry 1615-1630 may enable and cause the communications device 1600 to perform the method 1300 described with respect to FIG. 13, or any aspect related to it. For instance, in some aspects, circuitry for receiving 1615 includes circuitry for receiving, from a first network entity, a first indication of a measurement resource associated with measurement of interference from a second network entity to the CPE, the measurement resource associated with a second indication from the second network entity to the first network entity of the measurement resource. In some aspects, circuitry for performing 1620 includes circuitry for performing, on the measurement resource, the measurement of interference from the second network entity to the CPE. In some aspects, circuitry for transmitting 1625 includes circuitry for transmitting, to the first network entity, a report regarding the measurement resource.

More generally, means for communicating, transmitting, sending or outputting for transmission may include the one or more transceivers 324, one or more antenna 322 and/or processing system 316 of the UE 304 illustrated in FIG. 3, transceiver 1665 and/or antenna 1670 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1665 and/or antenna 1670 of the communications device 1600 in FIG. 16, and/or one or more processors 1610 of the communications device 1600 in FIG. 16.

FIG. 17 depicts aspects of an example communications device configured for wireless communications. In some aspects, communications device 1700 is a network entity, such as BS 102 of FIG. 1, first network entity 300 or second network entity 302 of FIG. 3, or a disaggregated base station as discussed with respect to FIG. 2.

The communications device 1700 includes a processing system 1702 coupled to a transceiver 1738 (e.g., a transmitter and/or a receiver) and/or a network interface 1742. The transceiver 1738 is configured to transmit and receive signals for the communications device 1700 via an antenna 1740, such as the various signals as described herein. The network interface 1742 is configured to obtain and send signals for the communications device 1700 via communications link(s), such as a backhaul link, midhaul link, and/or fronthaul link as described herein, such as with respect to FIG. 2. The processing system 1702 may be configured to perform processing functions for the communications device 1700, including processing signals received and/or to be transmitted by the communications device 1700.

The processing system 1702 includes one or more processors 1704 and a computer-readable medium/memory 1720. In various aspects, one or more processors 1704 may be representative of the one or more processors 308, as described with respect to FIG. 3. The one or more processors 1704 are coupled to the computer-readable medium/memory 1720 via a bus 1736. In certain aspects, the computer-readable medium/memory 1720 is configured to store instructions (e.g., computer-executable code), including code 1722-1734, that when executed by the one or more processors 1704, cause the one or more processors 1704 to perform the method 1400 described with respect to FIG. 14, or any aspect related to it, including any operations described in relation to FIG. 14; and the method 1500 described with respect to FIG. 15, or any aspect related to it, including any operations described in relation to FIG. 15. The computer-readable medium/memory 1720 is a non-transitory computer-readable medium/memory. Note that reference to a processor of communications device 1700 performing a function may include one or more processors of communications device 1700 performing that function, such as in a distributed fashion.

In the depicted example, the computer-readable medium/memory 1720 stores code (e.g., executable instructions), including code for receiving 1722, code for providing 1724, code for performing 1726, code for sending 1728, code for scheduling 1730, code for switching 1732, and code for reducing 1734. Processing of the code 1722-1734 may enable and cause the communications device 1700 to perform the method 1400 described with respect to FIG. 14, or any aspect related to it; and the method 1500 described with respect to FIG. 15, or any aspect related to it. For instance, in some aspects, code for receiving 1722 includes code for receiving, from a second network entity, a first indication of a measurement resource. In some aspects, code for providing 1724 includes code for providing, to a CPE, a second indication of the measurement resource. In some aspects, code for receiving 1722 includes code for receiving, from the CPE, a report regarding the measurement resource. In some aspects, code for performing 1726 includes code for performing an action based on the report. For instance, in some aspects, code for sending 1728 includes code for sending, to a first network entity, an indication of a measurement resource associated with measurement of interference from the second network entity to the first network entity. In some aspects, code for receiving 1722 includes code for receiving, from the first network entity, information associated with a measurement of interference, at a CPE, on the measurement resource. In some aspects, code for performing 1726 includes code for performing an action based on the received information.

The one or more processors 1704 include circuitry configured to implement (e.g., execute) the code stored in the computer-readable medium/memory 1720, including circuitry for receiving 1706, circuitry for providing 1708, circuitry for performing 1710, circuitry for sending 1712, circuitry for scheduling 1714, circuitry for switching 1716, and circuitry for reducing 1718. Processing with circuitry 1706-1718 may enable and cause the communications device 1700 to perform the method 1400 described with respect to FIG. 14, or any aspect related to it; and the method 1500 described with respect to FIG. 15, or any aspect related to it. For instance, in some aspects, circuitry for receiving 1706 includes circuitry for receiving, from a second network entity, a first indication of a measurement resource. In some aspects, circuitry for providing 1708 includes circuitry for providing, to a CPE, a second indication of the measurement resource. In some aspects, circuitry for receiving 1706 includes circuitry for receiving, from the CPE, a report regarding the measurement resource. In some aspects, circuitry for performing 1710 includes circuitry for performing an action based on the report. For instance, in some aspects, circuitry for sending 1712 includes circuitry for sending, to a first network entity, an indication of a measurement resource associated with measurement of interference from the second network entity to the first network entity. In some aspects, circuitry for receiving 1706 includes circuitry for receiving, from the first network entity, information associated with a measurement of interference, at a CPE, on the measurement resource. In some aspects, circuitry for performing 1710 includes circuitry for performing an action based on the received information.

Various components of the communications device 1700 may provide means for performing the method 1400 described with respect to FIG. 14, or any aspect related to it; and the method 1500 described with respect to FIG. 15, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1738, antenna 1740, and/or network interface 1742 of the communications device 1700 in FIG. 17, and/or one or more processors 1704 of the communications device 1700 in FIG. 17. Means for communicating, receiving or obtaining may include the one or more transceivers 312, one or more antennas 314, and/or processing system 306 of the first network entity 300 or the second network entity 302 illustrated in FIG. 3, transceiver 1738, antenna 1740, and/or network interface 1742 of the communications device 1700 in FIG. 17, and/or one or more processors 1704 of the communications device 1700 in FIG. 17.

### Example Clauses

Implementation examples are described in the following numbered clauses:
Clause 1: A method for wireless communications by a customer premises equipment (CPE) comprising: receiving, from a first network entity, a first indication of a measurement resource associated with measurement of interference from a second network entity to the CPE, the measurement resource associated with a second indication from the second network entity to the first network entity of the measurement resource; performing, on the measurement resource, the measurement of interference from the second network entity to the CPE; and transmitting, to the first network entity, a report regarding the measurement resource.
Clause 2: The method of Clause 1, wherein the measurement resource comprises an inter-gNB CLI SSB measurement resource.
Clause 3: The method of any one of Clauses 1-2, wherein the measurement resource comprises a periodic non-zero power CSI reference signal measurement resource.
Clause 4: The method of any one of Clauses 1-3, wherein the measurement resource comprises a downlink channel reference signal resource.
Clause 5: The method of any one of Clauses 1-4, wherein the measurement resource comprises a semi persistently scheduled resource for a physical downlink shared channel.
Clause 6: The method of any one of Clauses 1-5, wherein the first indication comprises an identifier that indicates the second network entity.
Clause 7: The method of any one of Clauses 1-6, wherein the first indication of the measurement resource is received via one of RRC signaling or a MAC-CE.
Clause 8: The method of any one of Clauses 1-7, wherein the measurement resource comprises at least one of: a periodic resource, a semi-persistently scheduled resource, or an aperiodic resource.
Clause 9: The method of any one of Clauses 1-8, wherein the measurement resource conflicts with a configured downlink channel or reference signal transmission, and wherein the method further comprises dropping the configured downlink channel or reference signal transmission.
Clause 10: The method of Clause 9, wherein the configured downlink channel or reference signal transmission is dropped based on a first priority level of a downlink channel or reference signal associated with the configured downlink channel or reference signal transmission, wherein the first priority level of the downlink channel or reference signal is lower than a second priority level of the measurement resource.
Clause 11: The method of Clause 9, wherein the configured downlink channel or reference signal transmission is dropped based on a channel type of a downlink channel or reference signal associated with the configured downlink channel or reference signal transmission.
Clause 12: The method of Clause 9, wherein the configured downlink channel or reference signal transmission is dropped based on a third indication from the first network entity.
Clause 13: The method of any one of Clauses 1-12, wherein the measurement resource is a first measurement resource, wherein the method further comprises: receiving a third indication of a second measurement resource associated with a fourth indication from the second network entity to the first network entity of the second measurement resource, wherein the second measurement resource conflicts with a configured downlink channel or reference signal transmission, and wherein the method further comprises dropping the second measurement resource.
Clause 14: The method of any one of Clauses 1-13, wherein the measurement resource is a first measurement resource, wherein the method further comprises: receiving a third indication of a second measurement resource associated with a fourth indication from the second network entity to the first network entity of the second measurement resource, wherein the second measurement resource conflicts with a dynamically scheduled downlink channel or reference signal transmission, and wherein the method further comprises dropping the second measurement resource.
Clause 15: The method of any one of Clauses 1-14, wherein the measurement resource conflicts with a configured uplink channel or reference signal transmission, and wherein the method further comprises dropping the configured uplink channel or reference signal transmission.
Clause 16: The method of Clause 15, wherein the configured uplink channel or reference signal transmission is dropped based on a first priority level of an uplink channel or reference signal associated with the configured uplink channel or reference signal transmission, wherein the first priority level of the uplink channel or reference signal is lower than a second priority level of the measurement resource.
Clause 17: The method of Clause 15, wherein the configured uplink channel or reference signal transmission is dropped based on a channel type of an uplink channel or reference signal associated with the configured uplink channel or reference signal transmission.
Clause 18: The method of Clause 15, wherein the configured uplink channel or reference signal transmission is dropped based on a third indication from the first network entity.
Clause 19: The method of any one of Clauses 1-18, wherein the measurement resource is a first measurement resource, wherein the method further comprises: receiving a third indication of a second measurement resource associated with a fourth indication from the second network entity to the first network entity of the second measurement resource, wherein the second measurement resource conflicts with a configured uplink channel or reference signal transmission, and wherein the method further comprises dropping the second measurement resource.
Clause 20: The method of any one of Clauses 1-19, wherein the measurement resource is a first measurement resource, wherein the method further comprises: receiving a third indication of a second measurement resource associated with a fourth indication from the second network entity to the first network entity of the second measurement resource, wherein the second measurement resource conflicts with a dynamically scheduled uplink channel or reference signal transmission, and wherein the method further comprises dropping the second measurement resource.
Clause 21: The method of any one of Clauses 1-20, wherein the report regarding the measurement resource is in accordance with a periodic reporting configuration.
Clause 22: The method of any one of Clauses 1-21, wherein the report regarding the measurement resource is in accordance with a semi-persistent reporting configuration.
Clause 23: The method of any one of Clauses 1-22, wherein the report regarding the measurement resource is in accordance with an aperiodic triggering reporting configuration.
Clause 24: The method of any one of Clauses 1-23, further comprising receiving, from the first network entity, a trigger comprising one of UCI or a MAC-CE to trigger a transmission of the report regarding the measurement resource, wherein sending the report comprises sending the report in association with the trigger.
Clause 25: The method of any one of Clauses 1-24, wherein the report regarding the measurement resource comprises a reference signal received power measurement.
Clause 26: The method of any one of Clauses 1-25, wherein the report regarding the measurement resource comprises a received signal strength indicator measurement.
Clause 27: The method of any one of Clauses 1-26, wherein the report regarding the measurement resource is in accordance with a channel state information reporting configuration.
Clause 28: A method for wireless communications by a first network entity comprising: receiving, from a second network entity, a first indication of a measurement resource; providing, to a CPE, a second indication of the measurement resource; receiving, from the CPE, a report regarding the measurement resource; and performing an action based on the report.
Clause 29: The method of Clause 28, wherein the first network entity operates in a full duplex mode.
Clause 30: The method of any one of Clauses 28-29, wherein the first network entity operates in a sub-band full duplex mode.
Clause 31: The method of any one of Clauses 28-30, wherein the first network entity operates in a single frequency full duplex mode.
Clause 32: The method of any one of Clauses 28-31, wherein the first network entity operates in a time division duplex mode.
Clause 33: The method of any one of Clauses 28-32, wherein the measurement resource is associated with measurement of interference from a second network entity to the CPE.
Clause 34: The method of any one of Clauses 28-33, wherein the second network entity indicates the measurement resource to the first network entity using an Xn signaling interface.
Clause 35: The method of any one of Clauses 28-34, wherein the second network entity indicates the measurement resource to the first network entity using an F1AP signaling interface.
Clause 36: The method of any one of Clauses 28-35, wherein the report regarding the measurement resource is in accordance with a periodic reporting configuration.
Clause 37: The method of any one of Clauses 28-36, wherein the report regarding the measurement resource is in accordance with a semi-persistent reporting configuration.
Clause 38: The method of any one of Clauses 28-37, wherein the report regarding the measurement resource is in accordance with an aperiodic triggering reporting configuration.
Clause 39: The method of any one of Clauses 28-38, further comprising sending, to the CPE, a trigger comprising one of UCI or a MAC-CE to trigger a transmission of the report regarding the measurement resource, wherein receiving the report comprises receiving the report in association with the trigger.
Clause 40: The method of any one of Clauses 28-39, wherein the report regarding the measurement resource comprises a reference signal received power measurement.
Clause 41: The method of any one of Clauses 28-40, wherein the report regarding the measurement resource comprises a received signal strength indicator measurement.
Clause 42: The method of any one of Clauses 28-41, wherein the report regarding the measurement resource is in accordance with a channel state information reporting configuration.
Clause 43: The method of any one of Clauses 28-42, wherein the measurement resource comprises an inter-gNB CLI SSB measurement.
Clause 44: The method of any one of Clauses 28-43, wherein the measurement resource comprises a periodic non-zero power CSI reference signal measurement.
Clause 45: The method of any one of Clauses 28-44, wherein the measurement resource comprises a downlink channel reference signal.
Clause 46: The method of any one of Clauses 28-45, wherein the measurement resource comprises a semi persistent scheduling resource on a physical downlink shared channel.
Clause 47: The method of any one of Clauses 28-46, wherein the first indication comprises an identifier that indicates the second network entity.
Clause 48: The method of any one of Clauses 28-47, wherein the action based on the report comprises configuring a receiving beam, associated with lower than a threshold interference, for downlink reception at the CPE.
Clause 49: The method of any one of Clauses 28-48, further comprising: receiving, from the second network entity, information indicating a first downlink resource of the second network entity.
Clause 50: The method of Clause 49, wherein the action based on the report comprises scheduling one or more transmissions for the CPE on a second downlink resource separate from the first downlink resource.
Clause 51: The method of Clause 49, wherein the action based on the report comprises sending an indication to the CPE to disable a downlink beam based on the first downlink resource.
Clause 52: The method of Clause 49, wherein the action based on the report comprises sending, to the CPE, one or more transmissions with an increased transmission power for one or more downlink resources associated with the first downlink resource.
Clause 53: A method for wireless communications by a second network entity comprising: sending, to a first network entity, an indication of a measurement resource associated with measurement of interference from the second network entity to the first network entity; receiving, from the first network entity, information associated with a measurement of interference, at a CPE, on the measurement resource; and performing an action based on the received information.
Clause 54: The method of Clause 53, wherein the action comprises switching, based on the received information, from a first downlink beam associated with the measurement of interference to a second downlink beam.
Clause 55: The method of any one of Clauses 53-54, wherein the action comprises reducing, based on the received information, a transmit power for one or more transmissions on one or more downlink resources.
Clause 56: One or more apparatuses, comprising: one or more memories comprising executable instructions; and one or more processors configured to execute the executable instructions and cause the one or more apparatuses to perform a method in accordance with any one of Clauses 1-55.
Clause 57: One or more apparatuses configured for wireless communications, comprising: one or more memories; and one or more processors, coupled to the one or more memories, configured to cause the one or more apparatuses to perform a method in accordance with any one of Clauses 1-55.
Clause 58: One or more apparatuses configured for wireless communications, comprising: one or more memories; and one or more processors, coupled to the one or more memories, configured to perform a method in accordance with any one of Clauses 1-55.
Clause 59: One or more apparatuses, comprising means for performing a method in accordance with any one of Clauses 1-55.
Clause 60: One or more non-transitory computer-readable media comprising executable instructions that, when executed by one or more processors of one or more apparatuses, cause the one or more apparatuses to perform a method in accordance with any one of Clauses 1-55.
Clause 61: One or more computer program products embodied on one or more computer-readable storage media comprising code for performing a method in accordance with any one of Clauses 1-55.
Clause 62: One or more apparatuses configured for wireless communications, comprising: a processing system that includes one or more processors and one or more memories coupled with the one or more processors, the processing system configured to cause the one or more apparatuses to perform a method in accordance with any one of Clauses 1-55.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a customer premises equipment (CPE) to:
receive, from a first network entity, a first indication of a measurement resource associated with measurement of interference from a second network entity to the CPE, the measurement resource associated with a second indication from the second network entity to the first network entity of the measurement resource;
perform, on the measurement resource, the measurement of interference from the second network entity to the CPE; and
transmit, to the first network entity, a report regarding the measurement resource.

2. The apparatus of claim 1, wherein the measurement resource comprises an inter-gNB cross-link interference (CLI) synchronization signal block (SSB) measurement resource.

3. The apparatus of claim 1, wherein the measurement resource comprises a periodic non-zero power channel state information (CSI) reference signal measurement resource.

4. The apparatus of claim 1, wherein the first indication comprises an identifier that indicates the second network entity.

5. The apparatus of claim 1, wherein the measurement resource conflicts with a configured downlink channel or reference signal transmission, and wherein the processing system is configured to cause the CPE to drop the configured downlink channel or reference signal transmission.

6. The apparatus of claim 1, wherein the measurement resource is a first measurement resource, wherein the processing system is configured to cause the CPE to:
receive a third indication of a second measurement resource associated with a fourth indication from the second network entity to the first network entity of the second measurement resource, wherein the second measurement resource conflicts with a configured downlink channel or reference signal transmission, and wherein the processing system is configured to cause the CPE to drop the second measurement resource.

7. The apparatus of claim 1, wherein the measurement resource conflicts with a configured uplink channel or reference signal transmission, and wherein the processing system is configured to cause the CPE to drop the configured uplink channel or reference signal transmission.

8. The apparatus of claim 7, wherein the configured uplink channel or reference signal transmission is dropped based on a first priority level of an uplink channel or reference signal associated with the configured uplink channel or reference signal transmission, wherein the first priority level of the uplink channel or reference signal is lower than a second priority level of the measurement resource.

9. The apparatus of claim 1, wherein the processing system is configured to cause the CPE to receive, from the first network entity, a trigger comprising one of uplink control information (UCI) or a medium access control control element (MAC-CE) to trigger a transmission of the report regarding the measurement resource, wherein to cause the CPE to send the report, the processing system is configured to cause the CPE to send the report in association with the trigger.

10. An apparatus for wireless communications, comprising a processing system that includes one or more processors and one or more memories coupled with the one or more processors, the processing system configured to cause a first network entity to:
receive, from a second network entity, a first indication of a measurement resource;
provide, to a CPE, a second indication of the measurement resource;
receive, from the CPE, a report regarding the measurement resource; and
perform an action based on the report.

11. The apparatus of claim 10, wherein the measurement resource is associated with measurement of interference from a second network entity to the CPE.

12. The apparatus of claim 10, wherein the processing system is configured to cause the first network entity to send, to the CPE, a trigger comprising one of uplink control information (UCI) or a medium access control control element (MAC-CE) to trigger a transmission of the report regarding the measurement resource, wherein to cause the first network entity to receive the report, the processing system is configured to cause the first network entity to receive the report in association with the trigger.

13. The apparatus of claim 10, wherein the measurement resource comprises an inter-gNB cross-link interference (CLI) synchronization signal block (SSB) measurement.

14. The apparatus of claim 10, wherein the measurement resource comprises a periodic non-zero power channel state information (CSI) reference signal measurement.

15. The apparatus of claim 10, wherein the action based on the report comprises configuring a receiving beam, associated with lower than a threshold interference, for downlink reception at the CPE.

16. The apparatus of claim 10, wherein the processing system is configured to cause the first network entity to: receive, from the second network entity, information indicating a first downlink resource of the second network entity.

17. The apparatus of claim 16, wherein the action based on the report comprises scheduling one or more transmissions for the CPE on a second downlink resource separate from the first downlink resource.

18. The apparatus of claim 16, wherein the action based on the report comprises sending an indication to the CPE to disable a downlink beam based on the first downlink resource.

19. The apparatus of claim 16, wherein the action based on the report comprises sending, to the CPE, one or more transmissions with an increased transmission power for one or more downlink resources associated with the first downlink resource.

20. A method for wireless communications by a customer premises equipment (CPE) comprising:
receiving, from a first network entity, a first indication of a measurement resource associated with measurement of interference from a second network entity to the CPE, the measurement resource associated with a second indication from the second network entity to the first network entity of the measurement resource;
performing, on the measurement resource, the measurement of interference from the second network entity to the CPE; and
transmitting, to the first network entity, a report regarding the measurement resource.
